(19) United States
(12) Patent Application Publication
(10) Pub. No.: US 2025/0202751 A1
(43) Pub. Date: Jun. 19, 2025

(54) RECEIVER REPORTING-BASED CHANNEL AWARE TONE RESERVATION

(71) Applicant: QUALCOMM Incorporated, San Diego, CA (US)

(72) Inventors: Amit Bar-Or Tillinger, Tel-Aviv (IL); Gideon Shlomo Kutz, Ramat Hasharon (IL); Idan Michael Horn, Hod Hasharon (IL); Oren Matsrafi, Yad Modechai (IL)

(21) Appl. No.: 18/538,579

(22) Filed: Dec. 13, 2023

(51) Int. Cl. H04L 27/26; H04B 17/336; H04L 5/00; H04W 72/21

(52) U.S. Cl. CPC H04L 27/2618; H04B 17/336; H04L 5/0051; H04W 72/21

(57) ABSTRACT

This disclosure provides systems, methods, and apparatuses, including computer programs encoded on computer storage media, for wireless communication. Various aspects relate to channel aware tone reservation based on receiver reporting, and more particularly to a receiving device providing an indication of particular frequency tones to be reserved by a transmitting device for transmission of a peak-to-average power ratio (PAPR) reduction signal instead of data transmission or other signaling. The receiving device may perform channel measurements in association with one or more reference signals received from the transmitting device to identify one or more candidate tones. The one or more candidate tones may be reported by the receiving device to the transmitting device to enable transmission, by the transmitting device, of the PAPR reduction signal via one or more reserved tones and data transmission via one or more non-reserved tones. Other aspects and features are also claimed and described.

### TECHNICAL FIELD

This disclosure relates generally to wireless communication, and more specifically, to channel aware tone reservation associated with receiver reporting.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Although OFDMA has increased the amount of information that can be wireless communicated, as compared to technologies like CDMA or TDMA, OFDMA and orthogonal frequency multiplexing (OFDM) are associated with their own challenges and drawbacks. One challenge associated with OFDM-based wireless communications is that, because an OFDM waveform is the sum of multiple sinusoidal signals that can exhibit constructive and destructive interference, an OFDM signal's peak-to-average power ratio (PAPR) can vary at different times. A large PAPR can result in inefficient transmission by causing a power amplifier of a transmitting device to operate in a non-linear region, thereby creating signal distortion that degrades performance. One technique for addressing the challenges associated with large PAPR is for the transmitting device to transmit a PAPR reduction signal along with scheduled transmissions. For example, for each symbol of data or other signal being transmitted by the transmitting device, a small percentage of tones (e.g., subcarriers or frequency resources) of the symbol are used to transmit the PAPR reduction signal, and the remainder of tones are used to transmit the data or other signal. The PAPR reduction signal may increase the average signal power and thus reduce the PAPR, which improves a power amplifier operating point and therefore improves power amplifier efficiency as well as reduces transmission distortion by the transmitting device.

Although use of a PAPR reduction signal can reduce transmission distortion and improve power amplifier efficiency at the transmitting device, the PAPR reduction signal also reduces bandwidth because frequency resources that would otherwise be used to transmit data are reserved for transmitting the PAPR reduction signal. Although the PAPR reduction signal can typically be transmitted via any frequency tones without experiencing a reduction in the effectiveness of the PAPR reduction provided by the PAPR reduction signal due to channel conditions, poor channel conditions in the frequency tones used for data transmission can reduce the throughput from the transmitting device to a receiving device. As such, improper selection of tones for carrying the PAPR reduction signal can degrade throughput to such a degree that may negate, or reduce the effectiveness, of the throughput benefits provided by transmission of the PAPR signal.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later. The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes one or more processors and one or more memories coupled with the one or more processors. The one or more memories store processor-executable code that, when executed by the one or more processors, is configured to cause the wireless communication device to receive, from a transmitting device via a wireless channel between the wireless communication device and the transmitting device, one or more reference signals. The wireless communication device is also caused to transmit, to the transmitting device, a candidate tone report that indicates one or more candidate tones of the wireless channel. The one or more candidate tones are identified in association with one or more channel measurements associated with the one or more reference signals. The wireless communication device is caused to receive, from the transmitting device via a set of non-reserved tones of the wireless channel, a data transmission. The wireless communication device is further caused to discard one or more portions of a peak-to-average power ratio (PAPR) reduction signal that are received via a set of reserved tones of the wireless channel. The set of reserved tones include at least one of the one or more candidate tones.

Another innovative aspect of the subject matter described in this disclosure can be implemented in a method for wireless communication performed by a wireless communication device. The method includes receiving, from a transmitting device via a wireless channel between the wireless communication device and the transmitting device, one or more reference signals. The method also includes transmitting, to the transmitting device, a candidate tone report that indicates one or more candidate tones of the wireless channel. The one or more candidate tones are identified in association with one or more channel measurements associated with the one or more reference signals. The method includes receiving, from the transmitting device via a set of non-reserved tones of the wireless channel, a data transmission. The method further includes discarding one or more portions of a PAPR reduction signal that are received via a set of reserved tones of the wireless channel. The set of reserved tones include at least one of the one or more candidate tones.

Another innovative aspect of the subject matter described in this disclosure can be implemented in an apparatus configured for wireless communication. The apparatus includes means for receiving one or more reference signals from a transmitting device via a wireless channel between the apparatus and the transmitting device. The apparatus also includes means for transmitting a candidate tone report to the transmitting device. The candidate tone report indicates one or more candidate tones of the wireless channel. The one or more candidate tones are identified in association with one or more channel measurements associated with the one or more reference signals. The apparatus includes means for receiving a data transmission from the transmitting device via a set of non-reserved tones of the wireless channel. The apparatus further includes means for discarding one or more portions of a PAPR reduction signal that are received via a set of reserved tones of the wireless channel. The set of reserved tones include at least one of the one or more candidate tones.

Another innovative aspect of the subject matter described in this disclosure can be implemented in a non-transitory computer-readable medium storing instructions that, when executed by a processor, cause the processor to perform operations including receiving, from a transmitting device via a wireless channel between a wireless communication device and the transmitting device, one or more reference signals. The operations also include transmitting, to the transmitting device, a candidate tone report that indicates one or more candidate tones of the wireless channel. The one or more candidate tones are identified in association with one or more channel measurements associated with the one or more reference signals. The operations include receiving, from the transmitting device via a set of non-reserved tones of the wireless channel, a data transmission. The operations further include discarding one or more portions of a PAPR reduction signal that are received via a set of reserved tones of the wireless channel. The set of reserved tones include at least one of the one or more candidate tones.

Another innovative aspect of the subject matter described in this disclosure can be implemented in a wireless communication device. The wireless communication device includes one or more processors and one or more memories coupled with the one or more processors. The one or more memories store processor-executable code that, when executed by the one or more processors, is configured to cause the wireless communication device to transmit, to a receiving device via a wireless channel between the wireless communication device and the receiving device, one or more reference signals. The wireless communication device is also caused to receive, from the receiving device, a candidate tone report that indicates one or more candidate tones of the wireless channel. The one or more candidate tones are identified in association with one or more channel measurements of the one or more reference signals. The wireless communication device is caused to transmit, to the receiving device via a set of reserved tones of the wireless channel, a PAPR reduction signal. The set of reserved tones includes at least one of the one or more candidate tones. The wireless communication device is further caused to transmit, to the receiving device via a set of non-reserved tones of the wireless channel, a data transmission.

Another innovative aspect of the subject matter described in this disclosure can be implemented in a method for wireless communication performed by a wireless communication device. The method includes transmitting, to a receiving device via a wireless channel between the wireless communication device and the receiving device, one or more reference signals. The method also includes receiving, from the receiving device, a candidate tone report that indicates one or more candidate tones of the wireless channel. The one or more candidate tones are identified in association with one or more channel measurements of the one or more reference signals. The method includes transmitting, to the receiving device via a set of reserved tones of the wireless channel, a PAPR reduction signal. The set of reserved tones includes at least one of the one or more candidate tones. The method further includes transmitting, to the receiving device via a set of non-reserved tones of the wireless channel, a data transmission.

Another innovative aspect of the subject matter described in this disclosure can be implemented in an apparatus configured for wireless communication. The apparatus includes means for transmitting one or more reference signals to a receiving device via a wireless channel between the apparatus and the receiving device. The apparatus also includes means for receiving a candidate tone report from the receiving device. The candidate tone report indicates one or more candidate tones of the wireless channel. The one or more candidate tones are identified in association with one or more channel measurements of the one or more reference signals. The apparatus includes means for transmitting a PAPR reduction signal to the receiving device via a set of reserved tones of the wireless channel. The set of reserved tones includes at least one of the one or more candidate tones. The apparatus further includes means for transmitting a data transmission to the receiving device via a set of non-reserved tones of the wireless channel.

Another innovative aspect of the subject matter described in this disclosure can be implemented in a non-transitory computer-readable medium storing instructions that, when executed by a processor, cause the processor to perform operations including transmitting, to a receiving device via a wireless channel between a wireless communication device and the receiving device, one or more reference signals. The operations also include receiving, from the receiving device, a candidate tone report that indicates one or more candidate tones of the wireless channel. The one or more candidate tones are identified in association with one or more channel measurements of the one or more reference signals. The operations include transmitting, to the receiving device via a set of reserved tones, a PAPR reduction signal. The set of reserved tones includes at least one of the one or more candidate tones. The operations further include transmitting, to the receiving device via a set of non-reserved tones of the wireless channel, a data transmission.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports channel aware tone reservation based on receiver reporting according to one or more aspects.

FIG. 5 depicts a graph illustrating examples of channel aware tone reservation according to one or more aspects.

FIG. 6 is a ladder diagram illustrating an example of channel aware tone reservation based on receiver reporting according to one or more aspects.

FIG. 7 is a flow diagram illustrating an example process performable by a receiving device that supports channel aware tone reservation based on receiver reporting according to one or more aspects.

FIG. 8 is a block diagram of an example receiving device that supports channel aware tone reservation based on receiver reporting according to one or more aspects.

FIG. 9 is a flow diagram illustrating an example process performable by a transmitting device that supports channel aware tone reservation based on receiver reporting according to one or more aspects.

FIG. 10 is a block diagram of an example transmitting device that supports channel aware tone reservation based on receiver reporting according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The electromagnetic spectrum is often subdivided, based on frequency (or wavelength), into various classes, bands or channels. In fifth generation (5G) new radio (NR), two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band (or spectrum) in documents and articles, despite being different than the extremely high frequency (EHF) band (30 GHz-300 GHz) which is identified by the International Telecommunications Union (ITU) as a “millimeter wave” band. With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Various aspects relate generally to wireless communication, and more particularly, to channel aware tone reservation based on receiver reporting. Some aspects more specifically relate to supporting tone reservation of null tones or other tones associated with poor channel conditions to preserve the remaining better condition tones for data or other signal transmission. In some examples, a transmitting device may be scheduled to transmit data or other signaling to a receiving device during an upcoming time period. For example, the receiving device may be a user equipment (UE), the transmitting device may be a base station or other network entity, and the network entity may be scheduled to transmit a physical downlink shared channel (PDSCH) to the UE. As another example, the receiving device may be a first UE, the transmitting device may be a second UE, and the second UE may be scheduled to transmit a sidelink data channel to the first UE. The transmitting device may transmit one or more reference signals to the receiving device via a wireless channel, and the receiving device may perform one or more channel measurements in association with the reference signals to identify one or more candidate tones, e.g., subcarriers or other granularities of frequency resources, that satisfy or fail to satisfy tone selection criteria. For example, comparison with the tone selection criteria may result in the identification of one or more null tones or tones with low signal strength, high interference, or the like. Because the identified candidate tones are associated with poor channel conditions, as indicated by the result of the comparison, reservation of these tones for non-data transmission may provide the smallest reduction in throughput as compared to reservation of other tones that are associated with better channel conditions. The receiving device may transmit a candidate tone message that indicates the candidate tones to the transmitting device, and the transmitting device may reserve one or more of the candidate tones indicated in the tone reservation message for peak-to-average power ratio (PAPR) reduction instead of data or signaling. For example, the transmitting device may transmit a PAPR reduction signal via the reserved tones in combination with a data transmission via the remaining tones.

Particular implementations of the subject matter described in this disclosure can be implemented to realize one or more of the following potential advantages. In some aspects, the present disclosure supports a process for a network entity, such as a base station, to perform tone reservation for PAPR reduction in a channel aware manner based on reporting from a receiver. By reserving tones that are selected by the receiving device for PAPR reduction, a transmitting device may be able to reserve tones in a channel aware manner even in the absence of reciprocity between a transmission channel and a reception channel. For example, because the receiving device reports candidate tones of the reception channel that have the poorest channel conditions, the transmitting device is enabled to reserve tones of the reception channel that are least suited for data transmission without being able to directly measure the reception channel or without assuming reciprocity between the reception channel and the transmission channel. Such tone reservation for transmission of a PAPR reduction signal may provide a better tradeoff between the benefits of reduced transmission distortion and improved amplifier efficiency associated with PAPR reduction and the reduction in throughput associated with decreasing the amount of frequency resources allocated to data transmission. For example, by reserving tones that have low signal strength, high interference, or other poor channel conditions, for transmission of the PAPR reduction signal causes a smaller reduction in overall throughput because the reserved tones are the most likely to be associated with errors or reception failures, and thus less related to the overall throughput of the data transmission. As such, the techniques described herein may provide the benefits associated with PAPR reduction, such as improved transmission signal quality with reduced distortion, as well as a smaller reduction in throughput as compared to other PAPR reduction schemes that involve performing tone reservation randomly or that rely on reciprocity between the transmission channel and the reception channel.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1M nodes per km2), ultra-low complexity (such as ˜10s of bits per see), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.9999% reliability), ultra-low latency (such as ˜1 millisecond (ms)), and users with wide ranges of mobility or lack thereof; and (3) with enhanced mobile broadband including extreme high capacity (such as ˜10 Tbps per km2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

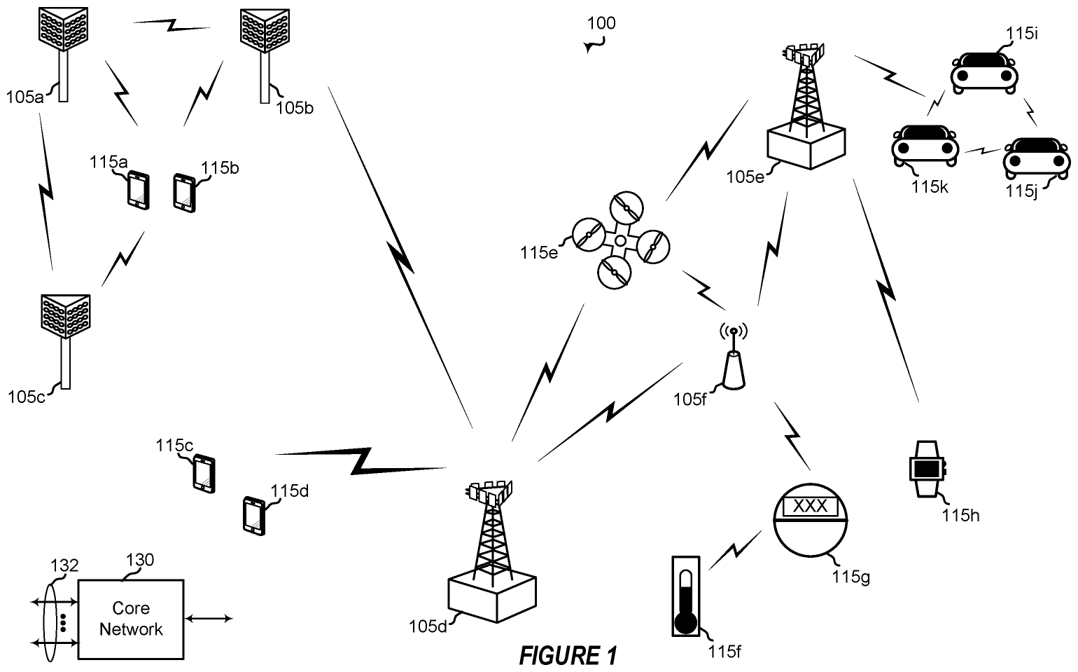

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

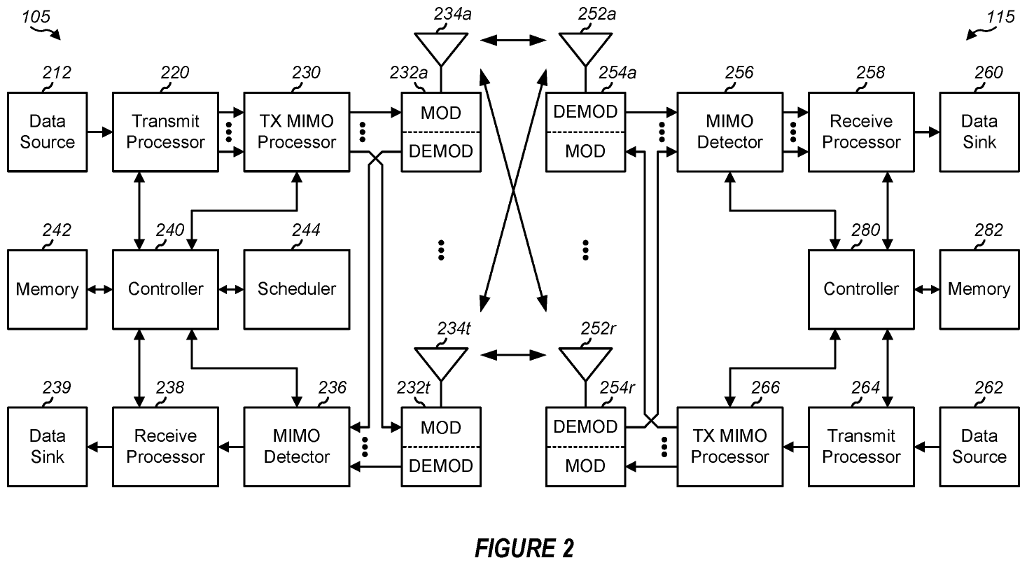

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

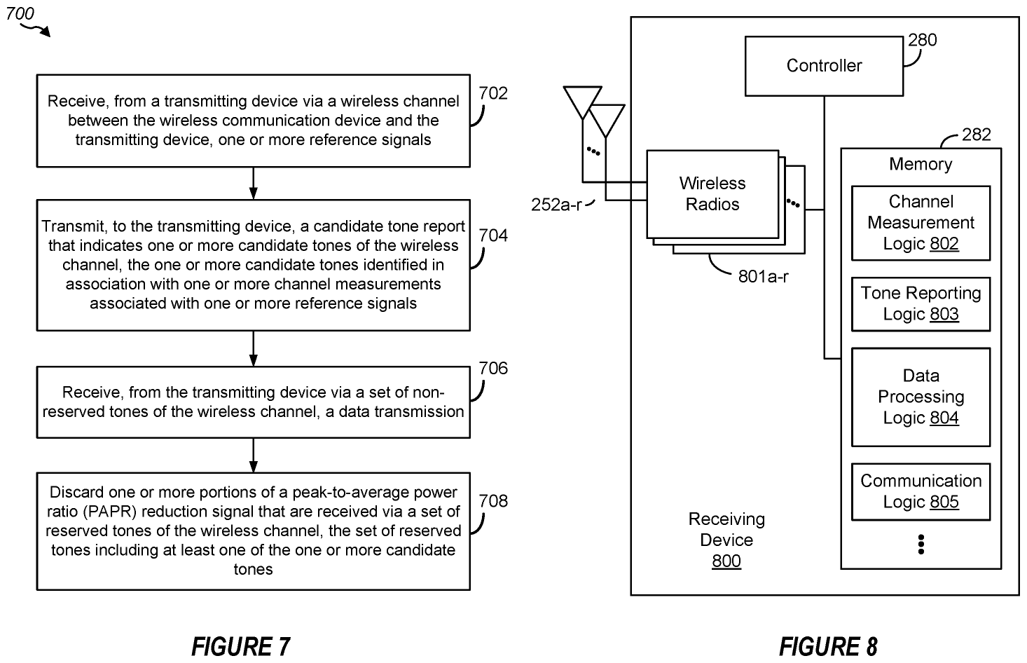

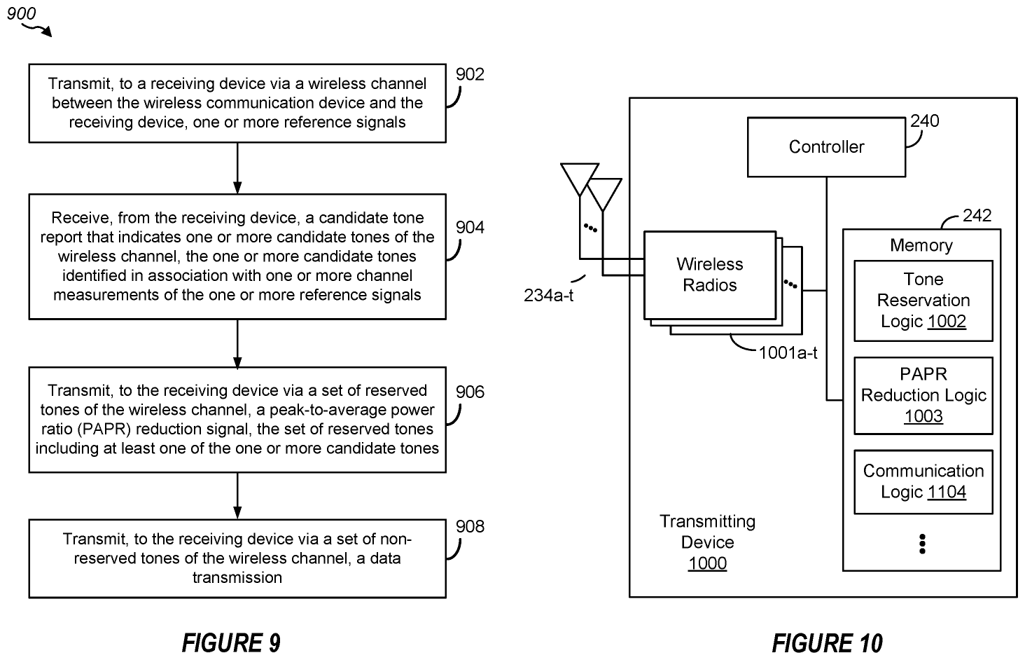

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 7 and 9, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

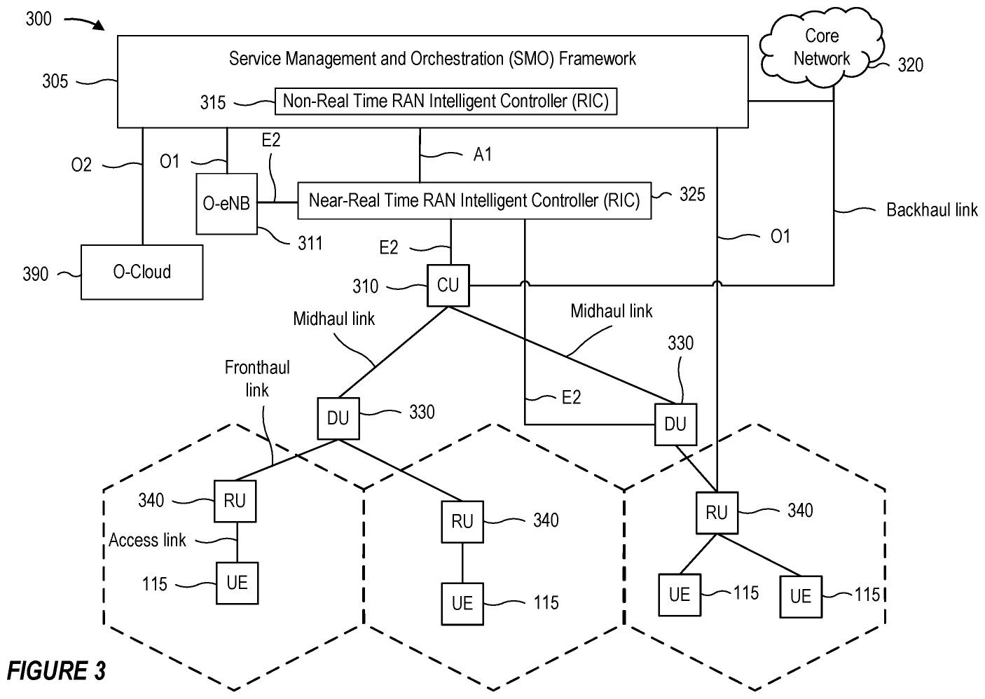

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

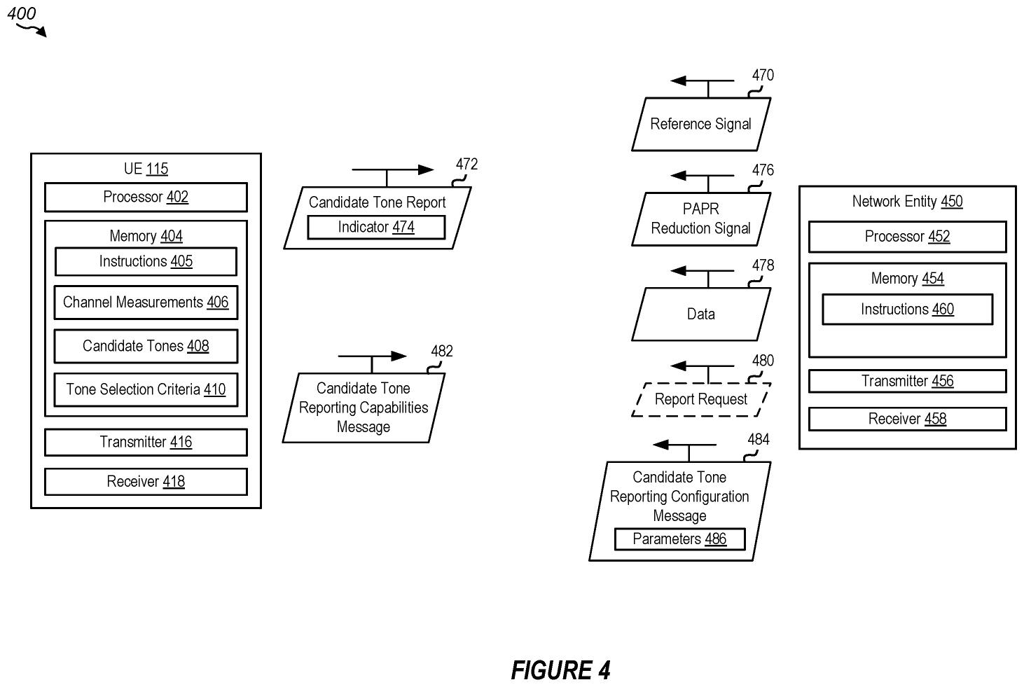

FIG. 4 is a block diagram of an example wireless communications system 400 that supports channel aware tone reservation based on receiver reporting according to one or more aspects. In some examples, the wireless communications system 400 may implement aspects of the wireless network 100. The wireless communications system 400 includes the UE 115 and a network entity 450, such as a base station. Although one UE 115 and one network entity 450 are illustrated, in some other implementations, the wireless communications system 400 may generally include multiple UEs 115, multiple network entities 450, or both.

The UE 115 can include a variety of components (such as structural, hardware components) used for carrying out one or more functions described herein. For example, these components can include one or more processors 402 (hereinafter referred to collectively as “the processor 402”), one or more memory devices 404 (hereinafter referred to collectively as “the memory 404”), one or more transmitters 416 (hereinafter referred to collectively as “the transmitter 416”), and one or more receivers 418 (hereinafter referred to collectively as “the receiver 418”). The processor 402 may be configured to execute instructions 405 stored in the memory 404 to perform the operations described herein. In some implementations, the processor 402 includes or corresponds to one or more of the receive processor 258, the transmit processor 264, and the controller 280, and the memory 404 includes or corresponds to the memory 282.

The memory 404 includes or is configured to the store instructions 405, channel measurements 406, candidate tones 408, and tone selection criteria 410. The channel measurements 406 may include or correspond to measurements of a wireless channel, such as a receive channel, between the UE 115 and the network entity 450 that are determined or derived using a reference signal from the network entity 450, as further described herein. The candidate tones 408 are one or more tones that are identified by the UE 115 based on the channel measurements 406 as satisfying the tone selection criteria 410. Although described as tones or subcarriers, in other implementations, the tones may instead be other granularities of frequency resources, resource blocks, physical resource blocks, sub-bands, bands, or any other granularity of frequency resource. The tone selection criteria 410 include criteria for selecting which frequency tones should be selected as candidates for PAPR reduction signal transmission instead of data transmission. For example, the tone selection criteria 410 may include one or more metrics, such as channel power, signal strength, signal-to-noise ratio (SNR), signal-to-interference-and-noise ratio (SINR), interference, or the like, one or more thresholds associated with the metrics, or other criteria for enabling tone selection, as further described herein.

The transmitter 416 is configured to transmit reference signals, control information and data to one or more other devices, and the receiver 418 is configured to receive references signals, synchronization signals, control information and data from one or more other devices. For example, the transmitter 416 may transmit signaling, control information and data to, and the receiver 418 may receive signaling, control information and data from, the network entity 450. In some implementations, the transmitter 416 and the receiver 418 may be integrated in one or more transceivers. Additionally or alternatively, the transmitter 416 or the receiver 418 may include or correspond to one or more components of the UE 115 described with reference to FIG. 2.

In some implementations, the UE 115 may include one or more antenna arrays. The one or more antenna arrays may be coupled to the transmitter 416, the receiver 418, or a communication interface. The antenna array may include multiple antenna elements configured to perform wireless communications with other devices, such as with the network entity 450. In some implementations, the antenna array may be configured to perform wireless communications using different beams, also referred to as antenna beams. The beams may include TX beams and RX beams. In some examples, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

The network entity 450 can include a variety of components (such as structural, hardware components) used for carrying out one or more functions described herein. For example, these components can include one or more processors 452 (hereinafter referred to collectively as “the processor 452”), one or more memory devices 454 (hereinafter referred to collectively as “the memory 454”), one or more transmitters 456 (hereinafter referred to collectively as “the transmitter 456”), and one or more receivers 458 (hereinafter referred to collectively as “the receiver 458”). The processor 452 may be configured to execute instructions 460 stored in the memory 454 to perform the operations described herein. In some implementations, the processor 452 includes or corresponds to one or more of the receive processor 238, the transmit processor 220, and the controller 240, and the memory 454 includes or corresponds to the memory 242. The memory 454 includes or is configured to store any information or data described herein with respect to operations of the network entity 450.

The transmitter 456 is configured to transmit reference signals, synchronization signals, control information and data to one or more other devices, and the receiver 458 is configured to receive reference signals, control information and data from one or more other devices. For example, the transmitter 456 may transmit signaling, control information and data to, and the receiver 458 may receive signaling, control information and data from, the UE 115. In some implementations, the transmitter 456 and the receiver 458 may be integrated in one or more transceivers. Additionally or alternatively, the transmitter 456 or the receiver 458 may include or correspond to one or more components of base station 105 described with reference to FIG. 2.

In some implementations, the network entity 450 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. In some examples, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the network entity 450. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, the wireless communications system 400 implements a 5G New Radio (NR) network. For example, the wireless communications system 400 may include multiple 5G-capable UEs 115 and multiple 5G-capable network entities 450, such as UEs and network entities configured to operate in accordance with a 5G NR network protocol such as that defined by the 3GPP.

During operation of the wireless communications system 400, the network entity 450 and the UE 115 may cooperate to support channel aware tone reservation based on reporting from the UE 115. Although described in the context of the UE 115 and the network entity 450, it should be appreciated the operations described with reference to FIG. 4 may be performed by any receiving device and transmitting device. In the example shown in FIG. 4, the receiving device is the UE 115, the transmitting device is the network entity 450, and channel measurements and tone reservations are performed and reported by the UE 115 for an uplink channel. As another example, the receiving device may be the network entity 450, the transmitting device may be the UE 115, and channel measurements and tone reservations may be performed and reported by the network entity 450 for a downlink channel. As another example, the receiving device may be the UE 115, the transmitting device may be another UE, and channel measurements and tone reservations may be performed and reported by the UE 115 for a sidelink channel. As such, the techniques described with reference to FIG. 4 are not limited to the particular devices or wireless channel described below, but to any wireless channel between a receiving device, e.g., a receiver, and a transmitting device, e.g., a transmitter.

As shown in FIG. 4, the network entity 450 may transmit a reference signal 470 to the UE 115. For example, the reference signal 470 may include a demodulation reference signal (DMRS), a channel state information reference signal (CSI-RS), a phase tracking reference signal (PTRS), or another type of reference signal. Although described as a reference signal, in some implementations, the network entity 450 may transmit multiple reference signals, such that one or more reference signals are received by the UE 115. In some implementations, the reference signal 470 may be precoded by the network entity 450 prior to transmission to the UE 115, such as a precoded DMRS or precoded PTRS. Alternatively, the reference signal 470 may not be precoded by the network entity 450 prior to transmission to the UE 115, such as a CSI-RS. The reference signal 470 may be transmitted to the UE 115 via a wireless channel between the UE 115, which acts as the receiving device or receiver, and the network entity 450, which acts as the transmitting device or transmitter.

The UE 115 may receive the reference signal 470 and may perform one or more channel measurement operations in accordance with the reference signal 470 to generate the channel measurements 406. For example, the UE 115 may measure a signal strength associated with the reference signal 470, a SNR associated with the wireless channel, a power level associated with the reference signal 470 or the wireless channel, a channel capacity associated with the wireless channel, other channel measurements, or a combination thereof, to generate the channel measurements 406. In particular, the UE 115 may perform channel measurement operations that generate the same type of measurements or metrics as the measurements or metrics included in the tone selection criteria 410.

The UE 115 may identifies the candidate tones 408 in association with (e.g., based on) the channel measurements 406 and the tone selection criteria 410. For example, the UE 115 may identify a subset of the channel measurements 406 that satisfy the tone selection criteria 410 (or that fail to satisfy the tone selection criteria 410), and the UE 115 may identify one or more tones that correspond to the subset of identified channel measurements as the candidate tones 408. The tone selection criteria 410 used to identify the candidate tones 408 may include received energy associated with the respective tones, signal to noise ratio (SNR) associated with the respective tones, channel capacity associated with the respective tones, channel power associated with the respective tones, other channel or signal metrics related to tones (or other granularities of frequency resources), or a combination thereof. As an example of candidate tone identification and selection, the UE 115 may identify one or more tones associated with SNR measurements that are less than a SNR threshold included in the tone selection criteria 410 as the candidate tones 408. As another example, the UE 115 may identify one or more tones associated with channel capacities that are less than a channel capacity threshold included in the tone selection criteria 410 as the candidate tones 408. As used herein, satisfying the tone selection criteria 410 may include being less than, or less than or equal to, a threshold unless otherwise described. By identifying tones that satisfy (or that fail to satisfy), or are associated with channel measurements that satisfy (or that fail to satisfy), the tone selection criteria 410, the UE 115 may select the candidate tones 408 that can be reserved for transmission of a PAPR reduction signal by the network entity 450 with the least reduction in throughput for other transmissions, such as data transmissions, from the network entity 450 to the UE 115.

After identifying the candidate tones 408, the UE 115 may transmit a candidate tone report 472 to the network entity 450. The candidate tone report 472 includes an indicator 474 of the candidate tones 408, thus enabling the network entity 450 to learn tones associated with poor channel conditions in an uplink channel without being able to directly measure the uplink channel itself. The candidate tone report 472 may be transmitted from the UE 115 to the network entity 450 via uplink control information (UCI), a medium access control (MAC) control element (MAC-CE), or a radio resource control (RRC) message.

The indicator 474 of the candidate tones 408 may indicate tones (or other granularities of frequency resources) in a variety of ways. In some implementations, the indicator 474 includes or corresponds to a list of resource indices that correspond to the candidate tones 408. For example, the indicator 474 may include a list of one or more resource indices that correspond to the one or more tones of the candidate tones 408. As another example, the indicator 474 may include a binary vector having a length that corresponds to the total number of tones in the wireless channel, and each value of the binary vector indicates whether the corresponding tone is reserved, or not, for PAPR reduction. In some other implementations, the indicator 474 indicates one or more frequency clusters that include the candidate tones 408. For example, the indicator 474 may include a list of cluster parameters associated with one or more frequency clusters that correspond to or include the candidate tones 408. In this example, the cluster parameters may include a beginning frequency and an ending frequency of each frequency cluster or a cluster center and a cluster width of each frequency cluster. In some other implementations, the indicator 474 is a differential indicator that indicates a difference between the most recently identified candidate tones. For example, the candidate tone report 472 may be a differential report that indicates changes between candidate tones indicated by a previous candidate tone report and the candidate tones 408. Such a differential report may reduce bandwidth associated with candidate tone reporting, as most frequency clusters or tones that satisfy the tone selection criteria 410 are unlikely to change very much between consecutive reports. The differential report may represent differences in resource indices, differences in frequency cluster parameters, or any other type of differential reporting.

In some implementations, the UE 115 may perform entropy encoding on the candidate tone report 472 prior to transmission of the report to the network entity 450. For example, the entropy encoding may replace each differing piece of information in the candidate tone report 472 with a unique prefix code that is then compressed by replacing the fixed-length information with variable-length prefix codewords. Entropy encoding may be particular effective at compressing the candidate tone report 472 in implementations in which the candidate tone report 472 is a differential report or includes a list of resource indices for tones. For example, all tones or frequency clusters that do not change in a differential report may be replaced with a small prefix code, with only the ones that change receiving larger prefix codes, thus compressing the size of the differential report. As another example, all resource indices that correspond to non-candidate tones can be similarly replaced with a small prefix code, with only the resource indices that correspond to candidate tones receiving a larger prefix code, thus compressing the size of the list. Additionally or alternatively, the UE 115 may encode the candidate tone report 472 based on a power delay profile (PDP). For example, the PDP may be related to the coherency of the wireless channel, such that if there is a small PDP strength there is a smooth wireless channel, and if there is a large PDP strength, there is less channel coherency. In situations with lower PDP strength, the UE 115 may use different encoding parameters, such as encoding parameters that provide higher compression, to take advantage of the better channel conditions and the decreased likelihood of errors or dropped packets as compared to if the PDP strength is higher.

The network entity 450 receives the candidate tone report 472 from the UE 115, and decodes the candidate tone report 472 in implementations in which the report is encoded. Upon receiving, and optionally decoding, the candidate tone report 472, the network entity 450 may determine the candidate tones 408 based on the indicator 474 and reserve at least one of the candidate tones 408 to PAPR signal transmission. For example, the network entity 450 may transmit a PAPR reduction signal 476 to the UE 115 via a set of reserved tones that includes at least one of the candidate tones 408 in addition to transmitting data 478 to the UE 115 via a set of non-reserved tones (or other frequency resources). In some examples, the network entity 450 may select one or more of the candidate tones 408 in association with other parameters and metrics known to the network entity 450 as the set of reserved tones. In some such examples, the network entity 450 may select one or more tones not included in the candidate tones 408 for inclusion in the set of reserved tones based on other considerations or parameters. Additionally or alternatively, the set of non-reserved tones may include one or more of the candidate tones 408 that are not included in the set of reserved tones, or the set of non-reserved tones may not include any of the candidate tones 408. The network entity 450 may select other parameters of the PAPR reduction signal 476 based on conditions of the network entity 450 and its components, in order to most effectively reduce PAPR of one or more power amplifiers of the network entity 450. The data 478 may include or correspond to any data transmission, or other signaling, scheduled by the network entity 450 for the UE 115 to support one or more wireless communication applications.

The UE 115 receives the PAPR reduction signal 476 from the network entity via the candidate tones 408, and the UE 115 receives the data 478 from the network entity 450 via the set of non-reserved tones. Because the UE 115 is not capable of decoding or otherwise interpreting the PAPR reduction signal 476, the UE 115 may discard the information received via the set of reserved tones while processing the data 478 received via the set of non-reserved tones. In this manner, the network entity 450 may wirelessly transmit the data 478 to the UE 115 with substantially similar throughput to normal data transmissions while also reducing distortion caused by high PAPR at the network entity 450.

In some implementations, the candidate tone report 472 is transmitted periodically. For example, the UE 115 may set a parameter to control a frequency with which the candidate tone report 472 is generated and transmitted to the network entity 450. In some other implementations, the candidate tone report 472 is transmitted upon request. For example, the network entity 450 may determine when candidate tone reporting updates are to be sent, and the network entity 450 may transmit a report request 480 to the UE 115. In response to receiving the report request 480 from the network entity 450, the UE 115 may transmit the candidate tone report 472. In some implementations, the network entity 450 may determine whether the candidate tone report 472 is to be transmitted periodically or upon request, and the network entity 450 may configure the UE 115 accordingly via control information or other signaling.

In some implementations, the network entity 450 and the UE 115 perform a capabilities exchange, such as during an association process or an initialization process. Such an initialization process may be performed a single time, such as during association, or periodically, although candidate tone reporting by the UE 115 is performed more frequently than the initialization process, such that the initialization process results in parameters that are used for multiple occurrences of tone reservation reporting. The capabilities exchange may include the UE 115 transmitting a candidate tone reporting capabilities message 482 to the network entity 450, and in response, the network entity 450 may transmit a candidate tone reporting configuration message 484 to the UE 115. The candidate tone reporting capabilities message 482 may include or indicate one or more candidate tone parameters supported by the UE 115, and the candidate tone reporting configuration message 484 may include or indicate candidate tone parameters 486 selected by the network entity 450 to be used by the UE 115 in providing the candidate tone report 472. The candidate tone parameters 486 may include the tone selection criteria 410, a maximum number of tone reservations per report, a maximum number of frequency clusters per report, a maximum number of layers (e.g., a rank) per report, a report granularity such as per tone/subcarrier, per resource block, etc., one or more entropy encoder parameters such as a Huffman dictionary, other parameters, or a combination thereof. The maximum number of reserved tones may be a particular number or a percentage of the available tones, and may be limited per component carrier or for all component carriers. Upon receiving the candidate tone reporting configuration message 484, the UE 115 may generate the channel measurements 406, configure transmission of the candidate tone report 472, or both, in accordance with the candidate tone parameters 486.

As described with reference to FIG. 4, the present disclosure provides techniques for performing tone reservation for PAPR reduction in a channel aware manner based on reporting from a receiver. By reserving the candidate tones 408 that are selected by the UE 115 based on the channel measurements 406, the network entity 450 may be able to select tones in a channel aware manner even without reciprocity between a transmission channel, such as a downlink channel, and a reception channel, such as an uplink channel. For example, the UE 115 may receive the reference signal 470 via the reception channel and, based on the channel measurements 406, the UE 115 may identify and report the candidate tones 408 that have the worst channel conditions (or that satisfy the tone selection criteria 410). Sending the candidate tone report 472 enables the network entity 450 to reserve tones that are least suited for data transmission without being able to directly measure the reception channel or without assuming reciprocity between the reception channel and the transmission channel. Such tone selection, and transmission of the PAPR reduction signal 476 via the candidate tones 408, may provide a better tradeoff between the benefits of reduced transmission distortion at the network entity 450 associated with PAPR reduction and the reduction in throughput associated with decreasing the amount of frequency resources allocated to transmission of the data 478. For example, by selecting the candidate tones 408 that have low signal strength, high interference, or other poor channel conditions, for carrying the PAPR reduction signal 476 causes a smaller reduction in overall throughput because the candidate tones 408 are the most likely to be associated with errors or reception failures, and thus less related to the overall throughput of transmission of the data 478. As such, the wireless communications system 400 may provide the benefits associated with PAPR reduction, such as improved transmission signal quality with reduced distortion at the network entity 450, as well as a smaller reduction in throughput as compared to other PAPR reduction schemes that perform tone reservation randomly or rely on reciprocity between the transmission channel and the reception channel.

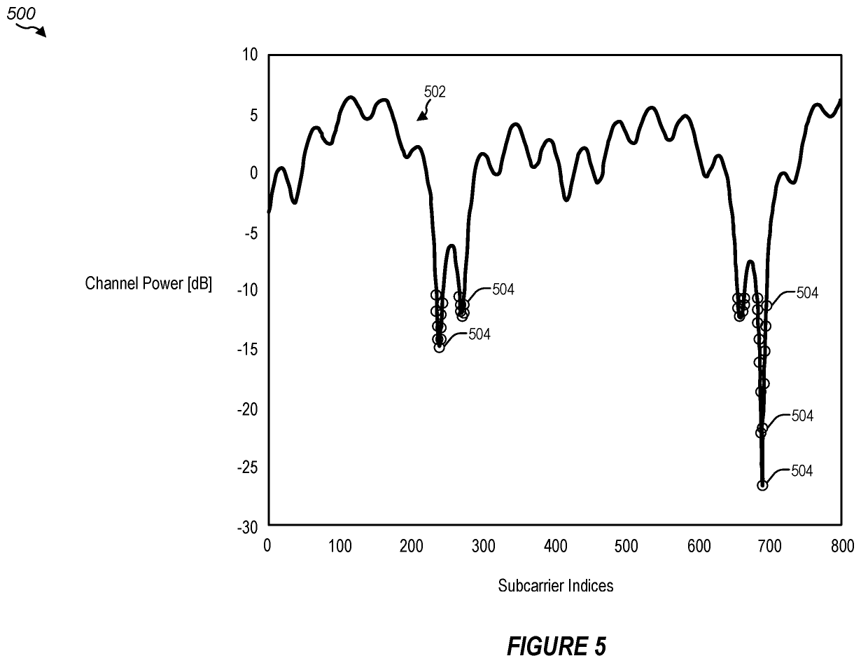

FIG. 5 depicts a graph 500 illustrating examples of channel aware tone reservation according to one or more aspects of the present disclosure. In some implementations, the examples of tone reservation described with reference to FIG. 5 may include or correspond to the candidate tones 408 of FIG. 4. The graph 500 includes a channel power curve 502 that represents the power, in dB, of a wireless channel for various subcarriers, e.g., tones. As described above with reference to FIG. 4, a receiving device, such as a UE, may identify one or more subcarriers that satisfy (or fail to satisfy) tone selection criteria for reporting to a transmitting device, such as a network entity. In the example shown in FIG. 5, the tone selection criteria may include a channel power threshold of approximately −10 dB, and the receiving device may identify subcarriers 504 that satisfy the threshold, and subcarriers 504 may be included in a tone reservation report for enabling the transmitting device to allocate subcarriers 504 to transmission of a PAPR reduction signal. Thus, FIG. 5 represents an example of channel aware tone reservation that allocates tones associated with low channel power (the subcarriers 504) to transmission of a PAPR reduction signal to retain the tones associated with better channel conditions, such as higher channel power, for data transmission.

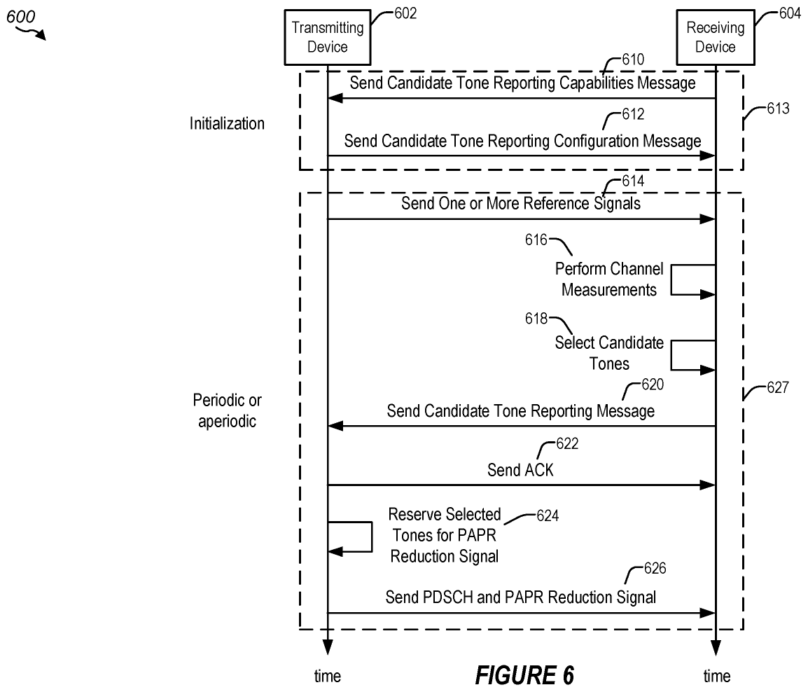

FIG. 6 is a ladder diagram 600 illustrating an example of channel aware tone reservation based on UE reporting according to one or more aspects. Operations described with respect to the ladder diagram 600 may be performed by a transmitting device 602 or a receiving device 604. In some implementations, the transmitting device 602 includes or corresponds to a network entity, such as the network entity 450 of FIG. 4, and the receiving device 604 includes or corresponds to a UE, such as the UE 115 of FIG. 4. In other implementations, the transmitting device 602 may be a UE or another type of wireless communication device, the receiving device 604 may be a network entity such as a base station or another type of wireless communication device, or both.

The receiving device 604 sends a candidate tone reporting capabilities message 610 to the transmitting device, at 610. The candidate tone reporting capabilities message may include one or more candidate tone parameters that are supported by the receiving device 604, similar to the candidate tone reporting capabilities message 482 of FIG. 4. The transmitting device 602 may receive the candidate tone reporting capabilities message and select one or more candidate tone parameters to be configured at the receiving device 604. Upon selection of the candidate tone parameters, the transmitting device 602 may send a candidate tone reporting configuration message to the receiving device 604, at 612. The candidate tone reporting configuration message may include or indicate one or more candidate tone parameters, of the parameters reported in the candidate tone reporting capabilities message, that are to be used by the receiving device 604 to perform channel measurement and candidate tone selection operations, similar to the candidate tone reporting configuration message 484 and the candidate tone parameters 486 of FIG. 4. The operations described at 610 and 612 may be part of an initialization phase 613 that is performed once, such as during association between the transmitting device 602 and the receiving device 604, or periodically according to a first periodicity.

The transmitting device 602 may transmit one or more reference signals to the receiving device 604, at 614. For example, the one or more reference signals may include a DMRS, a CSI-RS, or another type of reference signal. In accordance with the candidate tone parameters, the receiving device 604 may perform channel measurements in association with the one or more reference signals, at 616. For example, the channel measurements may measure a channel power, a channel capacity, a SNR, a signal strength, other metrics or measurements, or a combination thereof, associated with the reference signal and a wireless channel between the receiving device 604 and the transmitting device 602. The receiving device 604 may select one or more candidate tones (or other frequency resource granularities), at 618. For example, the receiving device 604 may identify one or more candidate tones that are associated with channel measurements that satisfy (or that fail to satisfy) one or more tone selection criteria, such as a channel power threshold, a channel capacity threshold, a SNR threshold, a signal strength threshold, other criteria, or a combination thereof.

The receiving device 604 may send a candidate tone reporting message that indicates the candidate tones to the transmitting device 602, at 620. For example, the candidate tone reporting message may include or correspond to the candidate tone report 472 of FIG. 4. In response to successfully receiving the candidate tone reporting message, the transmitting device 602 may transmit an acknowledgement to the receiving device 604, at 622. The transmitting device 602 may reserve at least one of the candidate tones for transmission of a PAPR reduction signal, at 624. For example, the candidate tones indicated by the candidate tone reporting message may be allocated to or reserved for transmission of the PAPR signal by the transmitting device 602. The transmitting device 602 may transmit the PAPR reduction signal and data, such as via a PDSCH, to the receiving device 604, at 626. The PAPR reduction signal may be transmitted via a set of reserved tones, and the PDSCH may be transmitted by a set of non-reserved tones, such as tones that are not reserved for PAPR reduction signal transmission. In response to receiving the transmissions, the receiving device 604 may discard the information received via the reserved tones. For example, because the receiving device 604 is not configured to decode the PAPR reduction signal, the receiving device 604 may discard or otherwise ignore anything received via the set of reserved tones and only process the data via the set of non-reserved tones.

The operations described at 614-626 may be part of a periodic or aperiodic phase 627. In some implementations, the operations of the periodic or aperiodic phase 627 are performed periodically, according to one or more of the parameters negotiated during the initialization phase 613. The periodic performance of the periodic or aperiodic phase 627 may be performed more frequently than the initialization phase 613, such that the parameters negotiated during the initialization phase 613 are used for multiple iterations of the periodic or aperiodic phase 627. Alternatively, the operations of the periodic or aperiodic phase 627 may be performed a periodically. For example, the operations of the periodic or aperiodic phase 627 may be performed on demand in association with a report request transmitted by the transmitting device 602 to the receiving device 604. As another example, the transmitting device 602 may trigger performance of the operations of the periodic or aperiodic phase 627 by transmitting the reference signal.

FIG. 7 is a flow diagram illustrating an example process 700 performable by a receiving device that supports channel aware tone reservation based on receiver reporting according to one or more aspects of the present disclosure. The operations of the process 700 may be performed by receiving device or its components as described herein. In some examples, the receiving device may be a UE, and the reporting may be provided in uplink communications. For example, the process 700 may be performed by the UE 115 described above with reference to FIGS. 1-4, the receiving device 604 described above with reference to FIG. 6, or a receiving device described with reference to FIG. 8. In some other examples, the receiving device may be a different device, and the receiver reporting may be provided in different communications, such as downlink or sidelink communications.

In block 702, the receiving device (e.g., a wireless communication device) receives, from a transmitting device via a wireless channel between the receiving device and the transmitting device, one or more reference signals. For example, the receiving device may include or correspond to the UE 115 of FIG. 4, the transmitting device may include or correspond to the network entity 450 of FIG. 4, and the one or more reference signals may include or correspond to the reference signal 470 of FIG. 4. In block 704, the receiving device transmits, to the transmitting device, a candidate tone reservation report that indicates one or more candidate tones of the wireless channel. The one or more candidate tones are identified in association with one or more channel measurements associated with the one or more reference signals. For example, the candidate tone report may include or correspond to the candidate tone report 472 of FIG. 4, and the one or more channel measurements may include or correspond to the channel measurements 406. In some implementations, the candidate tone report is transmitted via UCI, a MAC-CE, or a RRC message. In some implementations, the one or more channel measurements include received energy associated with the one or more candidate tones, SNR associated with the one or more candidate tones, or channel capacity associated with the one or more candidate tones.

In block 706, the receiving device receives, from the transmitting device via a set of non-reserved tones of the wireless channel, a data transmission. For example, the data transmission may include or correspond to the data 478 of FIG. 4. In block 710, the receiving device discards one or more portions of a PAPR reduction signal that are received via a set of reserved tones of the wireless channel. The set of reserved tones includes at least one of the candidate tones For example, the one or more portions of the PAPR reduction signal may include or correspond to the PAPR reduction signal 476 of FIG. 4.

In some implementations, the candidate tone report includes a list of resource indices that correspond to the one or more candidate tones. For example, the indicator 474 of FIG. 4 may include a list of resource indices of the candidate tones 408 or a binary vector that corresponds to available tones, and the elements of the binary vector that corresponds to the candidate tones 408 may have the same particular value. In some other implementations, the candidate tone report indicates one or more frequency clusters that include the one or more candidate tones. For example, the indicator 474 of FIG. 4 may indicate one or more frequency clusters that include the candidate tones 408. In some other implementations, the candidate tone report includes a differential report that indicates changes between candidate tones reserved by a previous candidate tone report and the one or more candidate tones. For example, the candidate tone report 472 of FIG. 4 may be a differential report that indicates changes in candidate tones from a previous candidate tone report.

In some implementations, the process 700 further includes performing entropy encoding on the candidate tone report prior to transmission to the transmitting device. For example, the UE 115 of FIG. 4 may perform entropy encoding, PDP-based encoding, another type of encoding, or a combination thereof, on the candidate tone report 472 prior to transmitting the candidate tone report 472 to the network entity 450.

In some implementations, the candidate tone report is transmitted periodically. For example, the candidate tone report 472 of FIG. 4 may be transmitted periodically in accordance with a parameter indicated in the candidate tone reporting configuration message 484. Alternatively, the candidate tone message may be transmitted a-periodically or on demand. For example, the process 700 may include receiving, from the transmitting device, a request for candidate tone reporting. The candidate tone report is transmitted in response to the request. For example, the request may include or correspond to the report request 480 of FIG. 4.

FIG. 8 is a block diagram of an example receiving device 800 that supports channel aware tone reservation based on receiver reporting according to one or more aspects of the present disclosure. The receiving device 800 may be configured to perform operations, including the blocks of the process 700 described with reference to FIG. 7. In some implementations, the receiving device 800 is a UE that includes the structure, hardware, and components shown and described with reference to the UE 115 of FIGS. 1-4. For example, the receiving device 800 includes the controller 280, which operates to execute logic or computer instructions stored in the memory 282, as well as controlling the components of the receiving device 800 that provide the features and functionality of the receiving device 800. The receiving device 800, under control of the controller 280, transmits and receives signals via the wireless radios 801a-r and the antennas 252a-r. The wireless radios 801a-r include various components and hardware, as illustrated in FIG. 2 for the UE 115, including the modulator and demodulators 254a-r, the MIMO detector 256, the receive processor 258, the transmit processor 264, and the TX MIMO processor 266.

As shown, the memory 282 may include (or be configured to store) channel measurement logic 802, tone reporting logic 803, data processing logic 804, and communication logic 805. The channel measurement logic 802 may be configured to perform one or more channel measurement operations based on one or more reference signals received by the receiving device 800. The tone reporting logic 803 may be configured be configured to generate a candidate tone report that indicates one or more candidate tones that can be used for PAPR reduction in association with the channel measurements. The data processing logic 804 may be configured to process data signals received by a set of non-reserved tones and to discard information received via a set of reserved tones that includes the candidate tones. The communication logic 805 may be configured to enable communication between the receiving device 800 and one or more other devices. The receiving device 800 may receive signals from or transmit signals to one or more transmitting devices, such as the base station 105 of FIGS. 1-3, the network entity 450 of FIG. 4, the transmitting device 602 of FIG. 6, or a transmitting device as illustrated in FIG. 10.

FIG. 9 is a flow diagram illustrating an example process 900 performable by a transmitting device that supports channel aware tone reservation based on receiver reporting according to one or more aspects of the present disclosure. Operations of the process 900 may be performed by a transmitting device or its components, as described herein. In some examples, the transmitting device may be a network entity, such as a base station or other network entity, and the receiver reporting may be received in uplink communications. For example, the process 900 may be performed by the base station 105 described above with reference to FIGS. 1-3, the network entity 450 described above with reference to FIG. 4, the transmitting device 602 as described above with reference to FIG. 6, or a transmitting device as described above with reference to FIG. 10. In some other examples, the transmitting device may be a different device, and the receiver reporting may be received in different communications, such as downlink or sidelink communications.

In block 902, the transmitting device (e.g., a wireless communication device) transmits, to a receiving device via a wireless channel between the transmitting communication device and the receiving device, one or more reference signals. For example, the transmitting device may include or correspond to the network entity 450 of FIG. 4, the receiving device may include or correspond to the UE 115 of FIG. 4, and the one or more reference signals may include or correspond to the reference signal 470 of FIG. 4.

In block 904, the transmitting device receives, from the receiving device, a candidate tone report that indicates one or more candidate tones of the wireless channel. The one or more candidate tones are identified in association with one or more channel measurements of the one or more reference signals. For example, the candidate tone report may include or correspond to the candidate tone report 472 of FIG. 4, and the channel measurements may include or correspond to the channel measurements 406 of FIG. 4.

In block 906, the transmitting device transmits, to the receiving device via a set of reserved tones, a PAPR reduction signal. The set of reserved tones includes at least one of the one or more candidate tones. For example, the PAPR reduction signal may include or correspond to the PAPR reduction signal 476 of FIG. 4. In block 908, the transmitting device transmits, to the receiving device via a set of non-reserved tones of the wireless channel, a data transmission. For example, the data transmission may include or correspond to the data 478 of FIG. 4.

In some implementations, the process 900 further includes receiving, from the receiving device during an initialization process, candidate tone reporting capabilities associated with the receiving device and transmitting, to the receiving device, a candidate tone reporting configuration message that indicates one or more candidate tone parameters that correspond to the one or more channel measurements, the candidate tone report, or a combination thereof. For example, the candidate tone reporting capabilities may include or correspond to the candidate tone reporting capabilities message 482 of FIG. 4, and the candidate tone reporting configuration message may include or correspond to the candidate tone reporting configuration message 484 of FIG. 4. In some such implementations, the one or more candidate tone parameters include the tone selection criteria, a maximum number of candidate tones, a maximum number of frequency clusters, a maximum number of layers, a report granularity, one or more entropy encoder parameters, or a combination thereof. For example, the one or more candidate tone parameters may include or correspond to the candidate tone parameters 486 of FIG. 4.

In some implementations, the candidate tone report includes a list of resource indices that correspond to the one or more candidate tones. For example, the indicator 474 of FIG. 4 may include a list of resource indices of the candidate tones 408 or a binary vector that corresponds to available tones, and the elements of the binary vector that corresponds to the candidate tones 408 may have the same particular value. In some other implementations, the candidate tone report indicates one or more frequency clusters that include the one or more candidate tones. For example, the indicator 474 of FIG. 4 may indicate one or more frequency clusters that include the candidate tones 408. In some other implementations, the candidate tone report includes a differential report that indicates changes between candidate tones indicated by a previous candidate tone report and the one or more candidate tones. For example, the candidate tone report 472 of FIG. 4 may be a differential report that indicates changes in candidate tones from a previous candidate tone report.

FIG. 10 is a block diagram of an example transmitting device 1000 that supports channel aware tone reservation based on receiver reporting according to one or more aspects. The transmitting device 1000 may be configured to perform operations, including the blocks of process 900 described with reference to FIG. 9. In some implementations, the transmitting device 1000 is a network entity that includes the structure, hardware, and components shown and described with reference to base station 105 of FIGS. 1-3, or the network entity 450 of FIG. 4. For example, the transmitting device 1000 may include the controller 240, which operates to execute logic or computer instructions stored in the memory 242, as well as controlling the components of the transmitting device 1000 that provide the features and functionality of the transmitting device 1000. The transmitting device 1000, under control of the controller 240, transmits and receives signals via the wireless radios 1001a-t and the antennas 234a-t. The wireless radios 1001a-t include various components and hardware, as illustrated in FIG. 2 for the base station 105, including the modulator and demodulators the 232a-t, the transmit processor 220, the TX MIMO processor 230, the MIMO detector 236, and the receive processor 238.

As shown, the memory 242 may include (or be configured to store) tone reservation logic 1002, PAPR reduction logic 1003, and communication logic 1004. The tone reservation logic 1002 may be configured to receive a candidate tone report and to reserve one or more candidate tones identified in the report for use in reducing a PAPR. The PAPR reduction logic 1003 may be configured to facilitate transmission of a PAPR reduction signal via a set of reserved tones that includes at least one of the one or more candidate tones in combination with data transmission via a set of non-reserved tones. The communication logic 1004 may be configured to enable communication between transmitting device 1000 and one or more other devices. The transmitting device 1000 may receive signals from or transmit signals to one or more receiving devices, such as the UE 115 of FIGS. 1-4, the receiving device 604 of FIG. 6, or the receiving device 800 of FIG. 8.

It is noted that one or more blocks (or operations) described with reference to FIGS. 7 and 9 may be combined with one or more blocks (or operations) described with reference to another of the figures. For example, one or more blocks (or operations) of FIG. 7 may be combined with one or more blocks (or operations) of FIG. 9. As another example, one or more blocks associated with FIG. 7 or 9 may be combined with one or more blocks (or operations) associated with FIGS. 1-6. Additionally, or alternatively, one or more operations described above with reference to FIGS. 1-4 may be combined with one or more operations described with reference to FIG. 8 or 10.

In one or more aspects, techniques for channel aware tone reservation based on receiver reporting may include additional aspects, such as any single aspect or any combination of aspects described below or in connection with one or more other processes or devices described elsewhere herein. In some examples, the techniques one or more aspects may be implemented in a method or process. In some other examples, the techniques of one or more aspects may be implemented in a wireless communication device, such as a UE or a component of a UE. In some examples, the wireless communication device may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium storing instructions or having program code stored thereon that, when executed by the processing unit or system, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein. In some other examples, the techniques of one or more aspects may be implemented in a network entity, such as a base station, a component of a base station, a server, a component of a server, another network entity, or a component of another network entity. In some examples, the network entity may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium storing instructions or having program code stored thereon that, when executed by the processing unit or system, is configured to cause the network entity to perform the operations described herein. Additionally, or alternatively, the network entity may include an interface (e.g., a wireless communication interface) that includes a transmitter, a receiver, or a combination thereof. Additionally, or alternatively, the network entity may include one or more means configured to perform operations described herein.

Implementation examples are described in the following numbered clauses:

Clause 1: A wireless communication device, including: one or more processors; and one or more memories coupled with the one or more processors and storing processor-executable code that, when executed by the one or more processors, is configured to cause the wireless communication device to: receive, from a transmitting device via a wireless channel between the wireless communication device and the transmitting device, one or more reference signals; transmit, to the transmitting device, a candidate tone report that indicates one or more candidate tones of the wireless channel, the one or more candidate tones identified in association with one or more channel measurements associated with the one or more reference signals; receive, from the transmitting device via a set of non-reserved tones of the wireless channel, a data transmission; and discard one or more portions of a peak-to-average power ratio (PAPR) reduction signal that are received via a set of reserved tones of the wireless channel, the set of reserved tones including at least one of the one or more candidate tones.

Clause 2: The wireless communication device of clause 1, where the one or more channel measurements include received energy associated with the one or more candidate tones, signal to noise ratio (SNR) associated with the one or more candidate tones, or channel capacity associated with the one or more candidate tones.

Clause 3: The wireless communication device of clause 1, where the candidate tone report includes a list of resource indices that correspond to the one or more candidate tones.

Clause 4: The wireless communication device of clause 1, where the candidate tone report indicates one or more frequency clusters that include the one or more candidate tones.

Clause 5: The wireless communication device of clause 1, where the candidate tone report includes a differential report that indicates changes between candidate tones indicated by a previous candidate tone report and the one or more candidate tones.

Clause 6: The wireless communication device of clause 1, where the processor-executable code, when executed by the one or more processors, is configured to further cause the wireless communication device to: perform entropy encoding on the candidate tone report prior to transmission to the transmitting device.

Clause 7: The wireless communication device of clause 1, where the candidate tone report is transmitted via uplink control information (UCI), a medium access control (MAC) control element (MAC-CE), or a radio resource control (RRC) message.

Clause 8: The wireless communication device of clause 1, where the candidate tone report is transmitted periodically.

Clause 9: The wireless communication device of clause 1, where the processor-executable code, when executed by the one or more processors, is configured to further cause the wireless communication device to: receive, from the transmitting device, a request for candidate tone reporting, where the candidate tone report is transmitted in response to the request.

Clause 10: A method for wireless communication by a wireless communication device, including: receiving, from a transmitting device via a wireless channel between the wireless communication device and the transmitting device, one or more reference signals; transmitting, to the transmitting device, a candidate tone report that indicates one or more candidate tones of the wireless channel, the one or more candidate tones identified in association with one or more channel measurements associated with the one or more reference signals; receiving, from the transmitting device via a set of non-reserved tones of the wireless channel, a data transmission; and discarding one or more portions of a peak-to-average power ratio (PAPR) reduction signal that are received via a set of reserved tones of the wireless channel, the set of reserved tones including at least one of the one or more candidate tones.

Clause 11: The method of clause 10, where the one or more channel measurements include received energy associated with the one or more candidate tones, signal to noise ratio (SNR) associated with the one or more candidate tones, or channel capacity associated with the one or more candidate tones.

Clause 12: The method of clause 10, where the candidate tone report includes a list of resource indices that correspond to the one or more candidate tones.

Clause 13: The method of clause 10, where the candidate tone report indicates one or more frequency clusters that include the one or more candidate tones.

Clause 14: The method of clause 10, where the candidate tone report includes a differential report that indicates changes between candidate tones reserved by a previous candidate tone report and the one or more candidate tones.

Clause 15: The method of clause 10, further including: performing entropy encoding on the candidate tone report prior to transmission to the transmitting device.

Clause 16: The method of clause 10, where the candidate tone report is transmitted via uplink control information (UCI), a medium access control (MAC) control element (MAC-CE), or a radio resource control (RRC) message.

Clause 17: The method of clause 10, where the candidate tone report is transmitted periodically.

Clause 18: The method of clause 10, further including: receiving, from the transmitting device, a request for candidate tone reporting, where the candidate tone report is transmitted in response to the request.

Clause 19: A wireless communication device, including: one or more processors; and one or more memories coupled with the one or more processors and storing processor-executable code that, when executed by the one or more processors, is configured to cause the wireless communication device to: transmit, to a receiving device via a wireless channel between the wireless communication device and the receiving device, one or more reference signals; receive, from the receiving device, a candidate tone report that indicates one or more candidate tones of the wireless channel, the one or more candidate tones identified in association with one or more channel measurements of the one or more reference signals; transmit, to the receiving device via a set of reserved tones of the wireless channel, a peak-to-average power ratio (PAPR) reduction signal, the set of reserved tones including at least one of the one or more candidate tones; and transmit, to the receiving device via a set of non-reserved tones of the wireless channel, a data transmission.

Clause 20: The wireless communication device of clause 19, where the processor-executable code, when executed by the one or more processors, is configured to further cause the wireless communication device to: receive, from the receiving device during an association process, candidate tone reporting capabilities associated with the receiving device; and transmit, to the receiving device, a candidate tone reporting configuration message that indicates one or more candidate tone parameters that correspond to the one or more channel measurements, the candidate tone report, or a combination thereof.

Clause 21: The wireless communication device of clause 20, where the one or more candidate tone parameters include the tone selection criteria, a maximum number of candidate tones, a maximum number of frequency clusters, a maximum number of layers, a report granularity, one or more entropy encoder parameters, or a combination thereof.

Clause 22: The wireless communication device of clause 19, where the candidate tone report includes a list of resource indices that correspond to the one or more candidate tones.

Clause 23: The wireless communication device of clause 19, where the candidate tone reservation report indicates one or more frequency clusters that include the one or more candidate tones.

Clause 24: The wireless communication device of clause 19, where the candidate tone report includes a differential report that indicates changes between candidate tones indicated by a previous candidate tone report and the one or more candidate tones.

Clause 25: A method for wireless communication by a wireless communication device, including: transmitting, to a receiving device via a wireless channel between the wireless communication device and the receiving device, one or more reference signals; receiving, from the receiving device, a candidate tone report that indicates one or more candidate tones of the wireless channel, the one or more candidate tones identified in association with one or more channel measurements of the one or more reference signals; transmitting, to the receiving device via a set of reserved tones of the wireless channel, a peak-to-average power ratio (PAPR) reduction signal, the set of reserved tones including at least one of the one or more candidate tones; and transmitting, to the receiving device via a set of non-reserved tones of the wireless channel, a data transmission.

Clause 26: The method of device of clause 25, further including: receiving, from the receiving device during an association process, candidate tone reporting capabilities associated with the receiving device; and transmitting, to the receiving device, a candidate tone reporting configuration message that indicates one or more candidate tone parameters that correspond to the one or more channel measurements, the candidate tone report, or a combination thereof.

Clause 27: The method of clause 26, where the one or more candidate tone parameters include tone selection criteria, a maximum number of candidate tones, a maximum number of frequency clusters, a maximum number of layers, a report granularity, one or more entropy encoder parameters, or a combination thereof.

Clause 28: The method of clause 25, where the candidate tone report includes a list of resource indices that correspond to the one or more candidate tones.

Clause 29: The method of clause 25, where the candidate tone report indicates one or more frequency clusters that include the one or more candidate tones.

Clause 30: The method of clause 25, where the candidate tone report includes a differential report that indicates changes between candidate tones indicated by a previous candidate tone report and the one or more candidate tones.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A wireless communication device, comprising:
one or more processors; and
one or more memories coupled with the one or more processors and storing processor-executable code that, when executed by the one or more processors, is configured to cause the wireless communication device to:
receive, from a transmitting device via a wireless channel between the wireless communication device and the transmitting device, one or more reference signals;
transmit, to the transmitting device, a candidate tone report that indicates one or more candidate tones of the wireless channel, the one or more candidate tones identified in association with one or more channel measurements associated with the one or more reference signals;
receive, from the transmitting device via a set of non-reserved tones of the wireless channel, a data transmission; and
discard one or more portions of a peak-to-average power ratio (PAPR) reduction signal that are received via a set of reserved tones of the wireless channel, the set of reserved tones including at least one of the one or more candidate tones.

2. The wireless communication device of claim 1, wherein the one or more channel measurements include received energy associated with the one or more candidate tones, signal to noise ratio (SNR) associated with the one or more candidate tones, or channel capacity associated with the one or more candidate tones.

3. The wireless communication device of claim 1, wherein the candidate tone report includes a list of resource indices that correspond to the one or more candidate tones.

4. The wireless communication device of claim 1, wherein the candidate tone report indicates one or more frequency clusters that include the one or more candidate tones.

5. The wireless communication device of claim 1, wherein the candidate tone report includes a differential report that indicates changes between candidate tones indicated by a previous candidate tone report and the one or more candidate tones.

6. The wireless communication device of claim 1, wherein the processor-executable code, when executed by the one or more processors, is configured to further cause the wireless communication device to:
perform entropy encoding on the candidate tone report prior to transmission to the transmitting device.

7. The wireless communication device of claim 1, wherein the candidate tone report is transmitted via uplink control information (UCI), a medium access control (MAC) control element (MAC-CE), or a radio resource control (RRC) message.

8. The wireless communication device of claim 1, wherein the candidate tone report is transmitted periodically.

9. The wireless communication device of claim 1, wherein the processor-executable code, when executed by the one or more processors, is configured to further cause the wireless communication device to:
receive, from the transmitting device, a request for candidate tone reporting, wherein the candidate tone report is transmitted in response to the request.

10. A method for wireless communication by a wireless communication device, comprising:
receiving, from a transmitting device via a wireless channel between the wireless communication device and the transmitting device, one or more reference signals;
transmitting, to the transmitting device, a candidate tone report that indicates one or more candidate tones of the wireless channel, the one or more candidate tones identified in association with one or more channel measurements associated with the one or more reference signals;
receiving, from the transmitting device via a set of non-reserved tones of the wireless channel, a data transmission; and
discarding one or more portions of a peak-to-average power ratio (PAPR) reduction signal that are received via a set of reserved tones of the wireless channel, the set of reserved tones including at least one of the one or more candidate tones.

11. The method of claim 10, wherein the one or more channel measurements include received energy associated with the one or more candidate tones, signal to noise ratio (SNR) associated with the one or more candidate tones, or channel capacity associated with the one or more candidate tones.

12. The method of claim 10, wherein the candidate tone report includes a list of resource indices that correspond to the one or more candidate tones.

13. The method of claim 10, wherein the candidate tone report indicates one or more frequency clusters that include the one or more candidate tones.

14. The method of claim 10, wherein the candidate tone report includes a differential report that indicates changes between candidate tones reserved by a previous candidate tone report and the one or more candidate tones.

15. The method of claim 10, further comprising:
performing entropy encoding on the candidate tone report prior to transmission to the transmitting device.

16. The method of claim 10, wherein the candidate tone report is transmitted via uplink control information (UCI), a medium access control (MAC) control element (MAC-CE), or a radio resource control (RRC) message.

17. The method of claim 10, wherein the candidate tone report is transmitted periodically.

18. The method of claim 10, further comprising:
receiving, from the transmitting device, a request for candidate tone reporting, wherein the candidate tone report is transmitted in response to the request.

19. A wireless communication device, comprising:
one or more processors; and
one or more memories coupled with the one or more processors and storing processor-executable code that, when executed by the one or more processors, is configured to cause the wireless communication device to:
transmit, to a receiving device via a wireless channel between the wireless communication device and the receiving device, one or more reference signals;
receive, from the receiving device, a candidate tone report that indicates one or more candidate tones of the wireless channel, the one or more candidate tones identified in association with one or more channel measurements of the one or more reference signals;
transmit, to the receiving device via a set of reserved tones of the wireless channel, a peak-to-average power ratio (PAPR) reduction signal, the set of reserved tones including at least one of the one or more candidate tones; and
transmit, to the receiving device via a set of non-reserved tones of the wireless channel, a data transmission.

20. The wireless communication device of claim 19, wherein the processor-executable code, when executed by the one or more processors, is configured to further cause the wireless communication device to:
receive, from the receiving device during an association process, candidate tone reporting capabilities associated with the receiving device; and
transmit, to the receiving device, a candidate tone reporting configuration message that indicates one or more candidate tone parameters that correspond to the one or more channel measurements, the candidate tone report, or a combination thereof.

21. The wireless communication device of claim 20, wherein the one or more candidate tone parameters include tone selection criteria, a maximum number of candidate tones, a maximum number of frequency clusters, a maximum number of layers, a report granularity, one or more entropy encoder parameters, or a combination thereof.

22. The wireless communication device of claim 19, wherein the candidate tone report includes a list of resource indices that correspond to the one or more candidate tones.

23. The wireless communication device of claim 19, wherein the candidate tone report indicates one or more frequency clusters that include the one or more candidate tones.

24. The wireless communication device of claim 19, wherein the candidate tone report includes a differential report that indicates changes between candidate tones indicated by a previous candidate tone report and the one or more candidate tones.

25. A method for wireless communication by a wireless communication device, comprising:
transmitting, to a receiving device via a wireless channel between the wireless communication device and the receiving device, one or more reference signals;
receiving, from the receiving device, a candidate tone report that indicates one or more candidate tones of the wireless channel, the one or more candidate tones identified in association with one or more channel measurements of the one or more reference signals;
transmitting, to the receiving device via a set of reserved tones of the wireless channel, a peak-to-average power ratio (PAPR) reduction signal, the set of reserved tones including at least one of the one or more candidate tones; and
transmitting, to the receiving device via a set of non-reserved tones of the wireless channel, a data transmission.

26. The method of device of claim 25, further comprising:
receiving, from the receiving device during an association process, candidate tone reporting capabilities associated with the receiving device; and
transmitting, to the receiving device, a candidate tone reporting configuration message that indicates one or more candidate tone parameters that correspond to the one or more channel measurements, the candidate tone report, or a combination thereof.

27. The method of claim 26, wherein the one or more candidate tone parameters include tone selection criteria, a maximum number of candidate tones, a maximum number of frequency clusters, a maximum number of layers, a report granularity, one or more entropy encoder parameters, or a combination thereof.

28. The method of claim 25, wherein the candidate tone report includes a list of resource indices that correspond to the one or more candidate tones.

29. The method of claim 25, wherein the candidate tone report indicates one or more frequency clusters that include the one or more candidate tones.

30. The method of claim 25, wherein the candidate tone report includes a differential report that indicates changes between candidate tones indicated by a previous candidate tone report and the one or more candidate tones.
